(19) United States
(12) Patent Application Publication
(10) Pub. No.: US 2002/0086687 A1
(43) Pub. Date: Jul. 4, 2002

(54) System and method for synchronizing two master systems to one slave system

(75) Inventors: Juergen Kockmann, Duesseldorf (DE); Olaf Dicker, Rees (DE)

Correspondence Address: Siemens Corporation, Intellectual Property Department, 186 Wood Avenue South, Iselin, NJ, 08830, US

(73) Assignee: Siemens Information & Communication Products, Inc.

(21) Appl. No.: 09/754,906

(22) Filed: Jan. 4, 2001

(51) Int. Cl. H04Q 7/20

(52) U.S. Cl. 455/463; 455/462

(57) ABSTRACT

A cordless telephone system employing a base station (202) as slave and a plurality of handsets (204a, 204b) as masters is provided. The handsets (204a, 204b) periodically poll the base station. The base station (202) responds with acknowledge slots and also timing information whereby the handsets (204a, 204b) can adjust their poll timing so as avoid interfering with one another. If an active connection is set up between the base station (202) and a handset (204a), the other handset (204b) is not allowed to poll during the connection, effectively functioning as a system slave for the duration of the connection. Thus, the second handset (204b) stays synchronized to the first handset (204a) and listens until the connection is completed, whereupon it resumes normal functioning.

### BACKGROUND OF THE INVENTION

1. Field of the Invention

The present invention relates to telecommunication systems and, particularly, to a cordless telephone system in which multiple mobile units function as system masters.

2. Description of the Related art

Cordless telephone systems are becoming increasingly popular. Such systems are advantageous in that users are freed from the constraints of a wired telephone jack. Because of the desire for multiple extensions, advanced cordless systems employing multiple handsets with a single base station have been developed. However, such systems are relatively expensive.

Relatively inexpensive conventional basic cordless telephone systems employ a single base station unit, also referred to as a fixed part, and a single handset unit, also referred to as a mobile station or portable part. In such systems, the mobile unit is defined as system master, and the base station is defined as the system slave. This is done so as to save battery power in the handsets and thereby achieve better standby times. However, such systems are incapable of supporting more than one handset per base station, thereby limiting the ability to expand the system as usage demands.

Operation of such a system is described with reference to FIG. 1. Shown are a base station 102 and a handset 104. The base station 102 functions as system slave and the handset 104 functions as system master. If there is no connection between the handset 104 and the base station 102, the system is in idle mode. In this mode, the base station 102 listens continuously. The handset 104 polls the base station 102 periodically (for example, every 2000 milliseconds) by sending a transmit slot to the base station 102. The base station 102 responds with an acknowledge slot back to the handset 104. The acknowledge may also include additional status, etc., slots. After that, the handset 104 switches off again and will wake up after the next 2000 milliseconds.

In the idle state, the base station 102 will always find a handset because the base station 102 is the slave of the system. The slave can always synchronize to the timing of the master. Even if the master changes the timing during the time it was switched off, the slave can resynchronize the next time it receives the poll slot from the master. During an active connection, the base station will stay synchronized to the handset timing.

In a conventional systems, only one handset may be provided because more than one handset cannot be allowed to poll the base station at the same time. As such, there is a need for an ability to expand a basic cordless telephone system.

### SUMMARY OF THE INVENTION

These and other problems in the prior art are overcome in large part by a system and method according to the present invention. A cordless telephone system employing a base station as slave and a plurality of handsets as masters is provided. The handsets periodically poll the base station. The base station responds with acknowledge slots and also timing information whereby the handsets can adjust their poll timing so as avoid interfering with one another. If an active connection is set up between the base station and a handset, the other handset is not allowed to poll during the connection, effectively functioning as a system slave for the duration of the connection. Thus, the second handset stays synchronized to the first handset and listens until the connection is completed, whereupon it resumes normal functioning.

A base station according to an implementation of the present invention maintains a timing record and stays aware of when particular handsets will be polling. The base station is able to transmit poll responses to the handsets indicating that the handsets should adjust their poll timing so as to avoid conflicting with other handsets in the system. Correspondingly, handsets according to implementations of the present invention are able to adjust their poll timing responsive to signaling from the base station.

The base station is further capable of transmitting poll response signals to a handset as it is about to set up an active connection with the other handset. The signal advises the other handset to turn off its polling functionality, and listen for the other handset.

### BRIEF DESCRIPTION OF THE DRAWINGS

A better understanding of the invention is obtained when the following detailed description is considered in conjunction with the following drawings in which:

FIG. 1 is a block diagram of a prior art conventional cordless telephone system;

FIG. 2 is a block diagram of a cordless telephone system according to an implementation of the present invention;

FIG. 3 is a signaling diagram of an implementation of the present invention; and

FIG. 4 is a signaling diagram of an implementation of the present invention.

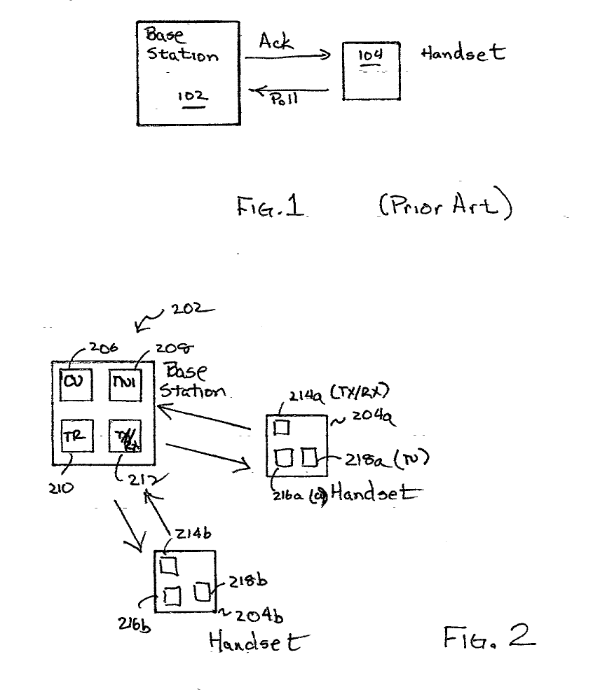

### DETAILED DESCRIPTION OF THE INVENTION

FIGS. 2-4 illustrate a telecommunications system including telecommunications devices according to an implementation of the present invention. A cordless telephone system employing a base station as slave and a plurality of handsets as masters is provided. The handsets periodically poll the base station. The base station responds with acknowledge slots and also timing information whereby the handsets can adjust their poll timing so as avoid interfering with one another. If an active connection is set up between the base station and a handset, the other handset is not allowed to poll during the connection, effectively functioning as a system slave for the duration of the connection. Thus, the second handset stays synchronized to the first handset and listens until the connection is completed, whereupon it resumes normal functioning.

Turning now to the drawings and, with particular attention to FIG. 2, a block diagram of an exemplary cordless telephone system is shown therein and generally identified by the reference numeral 200. The cordless telephone system 200 includes a base station or fixed part 202, and a plurality of handsets or portable parts 204a, 204b. It is noted that, while two handsets 204a, 204b are shown, a greater number may be provided. Thus, the figures are exemplary only.

The base station 202 includes a control unit (CU) 206, a telephone network interface (TNI) 208, a timer record (TRU) 210, and a transceiver (TX/RX) 212. The telephone network interface 208 typically interfaces to the public switched telephone network (PSTN) or integrated services digital network (ISDN), coupling to a private branch exchange (PBX) (not shown) or a central office (CO) (not shown). The transceiver 212 transmits and receives radio signals with the handsets 204a, 204b.

The control unit 206 may be implemented as software or firmware executable by one or more processors, such as microprocessors, microcontrollers, digital signal processors, or application specific integrated circuits (ASIC), as well as associated memory. The control unit 206 supervises the base station's functions and interfaces with the timer record 210, as will be explained in greater detail below. More particularly, the control unit 206 receives signaling from the transceiver 212 and the network interface 208, and sets up incoming and outgoing calls. Further, the control unit 206 receives the polling transmit slots from the handsets 204a, 204b, notes their timing in the timing record 210, and responds with appropriate acknowledge polling slots. The acknowledge polling slots may include instructions to one or more of the handsets to adjust their poll timing, if the control unit 206 determines that interference is likely. The acknowledge polling slots may include an actual time by which the next polling should be delayed or the time the next polling should occur, or may only instruct the handset to execute one or more predetermined default delays or timings. Further, prior to setting up a call with one handset, the base station 202 responds to poll slots from the other handset 204 by sending signals instructing that other handset to turn off its polling functionality.

The handsets 204a, 204b include transceivers (TX/RX) 214a, 214b, controllers (CU) 216a, 216b, and timers (TU) 218a, 218b, respectively. The transceivers 214a, 214b interface with the transceiver 212 of the base station 202, and with one another.

The controllers 216a, 216b issue polling transmit slots to the base station 202 periodically, on a time basis set by the timers 218a, 218b. Correspondingly, the controllers 216a, 216b receive acknowledge transmit slots from the base station 202 in response. Then, if necessary, they adjust their poll timers 218a, 218b such that the next polling does not interfere with that of the other handset(s). Further, if a handset, for example, handset 204a sets up a connection with the base station 202, the other handset 204b deactivates its polling functionality and synchronizes to the other handset. Then, when the call is over, the handset 204b resumes its polling. The controllers 216a, 216b may be implemented as software or firmware executable by one or more processors, such as microprocessors, microcontrollers, digital signal processors, or application specific integrated circuits (ASIC) as well as associated memory.

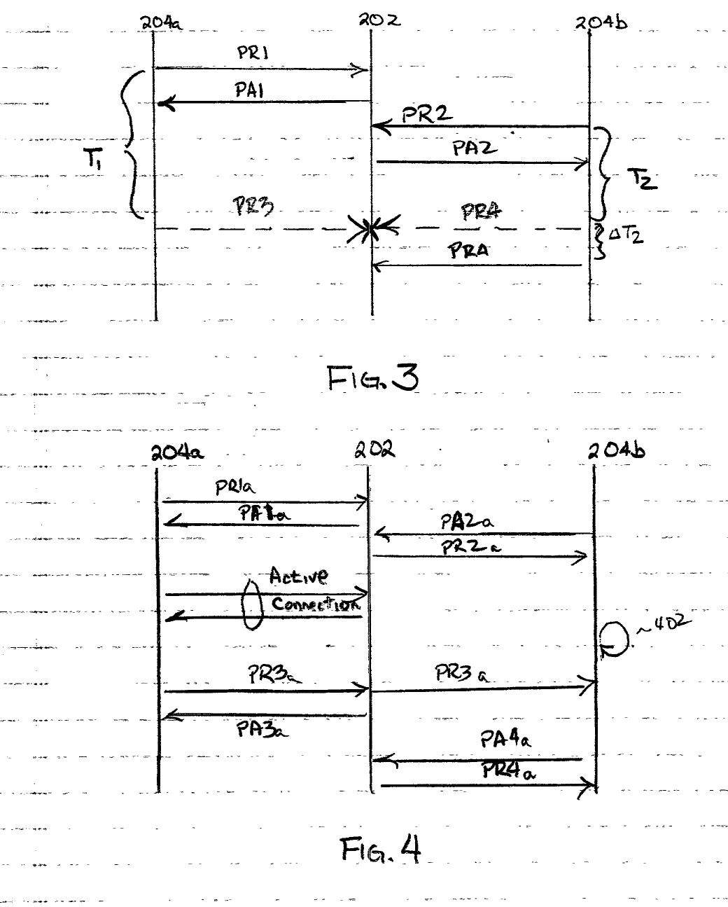

Turning now to FIG. 3, a diagram illustrating signal flow according to one implementation of the invention is shown. The signaling may be implemented, for example, by the respective controllers and transceivers of the handsets and base station. Prior to operation, the base station 202 and, in particular, the control unit 206 is initialized with the timing durations and the duration of responses for each of the handsets.

Initially, the handset 204a and, in particular, the controller 216a, sends a poll request PR1 to the base station 202. The base station 202 receives the poll request at its control unit 206, records the time in the timing record 210, and responds with a poll acknowledge PA1. The handset 204b's controller 216b also issues a poll request PR2 to the base station 202 at a later time. According to their internal timers 218a, 218b, the handset 204a and 204b are scheduled to issue their next poll requests at times T1 and T2, respectively. As illustrated by the dashed arrows, the resulting PR3 and PR4 would issue simultaneously. However, when the base station 202 receives the poll request PR2 from the handset 204b, its control unit 206 accesses the timing record 210 to determine when the next request exchange for each handset 204a, 204b is scheduled. If the base station 202 determines that the exchanges would interfere, the control unit 206 issues poll acknowledge slots PA2 instructing the handset 204b to alter the timing of its next poll request so as not to interfere with the handset 204a's next poll request. If there would be no interference, the standard acknowledge would be sent.

The handset 204b receives the poll acknowledge PA2, and its controller 216b changes the period of its timer 218b so that its next poll request PR4 occurs at time T2+ΔT and does not interfere. The change in timing may be preset, or may be provided during the poll acknowledge by the base station 202. It is noted that, while described with reference to different timing intervals T1, T2, it is also possible for there to be interference if the timing intervals are the same and would be handled in a similar fashion. Thus, the figure is exemplary only.

Turning now to FIG. 4, a diagram illustrating signaling during an active connection is shown. In the example shown, an active connection takes place between the handset 204a and the base station 202. Initially, the handset 204a issues a standard poll request PR1a and receives back a poll acknowledge PA1a. The poll acknowledge PA1a may contain, for example, signaling indicating to the handset 204a that a call from the external telephone network (not shown) is to be set up. Such signaling and call setup may be handled by the base station 202 in a known manner.

Before the call is set up, the base station 202 receives poll request signal PR2a from the handset 204b. The base station 202's control unit 206 responds with poll acknowledge PA2a, which contains signaling directing the handset 204b to turn off its polling functionality. The handset 204b's controller 216b does so, but listens for the instructions to turn back on. Next, the base station 202 and the handset 204a set up the call connection, for example, using standard call set up signaling.

When the call has ended, the handset 204a's control unit 206 resumes its polling and sends a poll request PR3a to the base station 202. The poll request is also received by the handset 204b. In response, the base station 202 issues a standard poll acknowledge PA3a. The handset 204b then knows that it can resume its polling functionality, as shown by the PR4a-PA4a exchange. It is noted that, in alternate embodiments, the base station 202 may directly send a resume polling signal to the handset 204b. In either case, the method described above with reference to FIG. 3 would continue to be implemented.

The invention described in the above detailed description is not intended to be limited to the specific form set forth herein, but is intended to cover such alternatives, modifications and equivalents as can reasonably be included within the spirit and scope of the appended claims.

What is claimed is:

1. A cordless telephone system, comprising:
a base station adapted to function as a slave;
a first handset unit adapted to function as a master;
a second handset unit adapted to function as a master;
said first and second handsets adapted to periodically poll said base station and receive commands responsive to which said first or second handset turns off said polling functionality when an active connection exists between said base station and said other of said first or second handsets.

2. A system in accordance with claim 1, wherein said first or second handset units receive commands responsive to which said first or second handset units reactivate said poling functionality when said active connection is disconnected.

3. A system in accordance with claim 2, wherein said first or second handsets receive commands responsive to said polling indicative of a new timing relationship for a next polling.

4. A cordless telephone system, comprising:
a base station adapted to function as a slave;
a first mobile unit adapted to function as a master;
a second mobile unit adapted to function as a master;
said first and second mobile units adapted to alternately function as a system slave when the other of said first or second mobile units has an active connection with said base station.

5. A cordless telephone system in accordance with claim 4, said first and second mobile units adapted to send polling signals to said base station when functioning as masters.

6. A cordless telephone system in accordance with claim 5, said base station adapted to respond to said polling signals by sending signals directing said first or second mobile units to adjust their poll timing.

7. A cordless telephone system in accordance with claim 6, wherein said alternately functioning as slaves comprises turning off polling functionality while said active connection is ongoing.

8. A cordless telephone system in accordance with claim 7, wherein said base station is adapted to respond to said polling signals by sending signals directing one of said first or second mobile units to turn off said polling functionality.

9. A cordless telephone system in accordance with claim 8, wherein a mobile station that has turned off said polling functionality is adapted to turn said polling functionality back on responsive to commands from said other of said first or second mobile units.

10. A method in a telecommunications system having a base station and at least first and second mobile units, comprising:
sending polling signals to said base station from said first and second mobile units; and
receiving at said first or second mobile units one or more signals directing said first or second mobile units to adjust a timing of said sending polling signals.

11. A method in accordance with claim 10, further comprising receiving at one of said first or second mobile units a signal from said base station responsive to polling directing said mobile unit to turn off polling functionality during an active connection between said base station and the other of said first or second mobile units.

12. A method in accordance with claim 11, further comprising said one turning said polling functionality back on responsive to a signal from said other of said first or second mobile units.

13. A method, comprising:
providing a base station adapted to function as a slave;
providing a first mobile unit adapted to function as a master;
providing a second mobile unit adapted to function as a master;
said first and second mobile units adapted to alternately function as a system slave when the other of said first or second mobile units has an active connection with said base station.

14. A method in accordance with claim 13, said first and second mobile units adapted to send polling signals to said base station when functioning as masters.

15. A method in accordance with claim 14, said base station adapted to respond to said polling signals by sending signals directing said first or second mobile units to adjust their poll timing.

16. A method in accordance with claim 15, wherein said alternately functioning as slaves comprises turning off polling functionality while said active connection is ongoing.

17. A method in accordance with claim 16, wherein said base station is adapted to respond to said polling signals by sending signals directing one of said first or second mobile units to turn off said polling functionality.

18. A method in accordance with claim 17, wherein a mobile station that has turned off said polling functionality is adapted to turn said polling functionality back on responsive to commands from said other of said first or second mobile units.
